(19) United States
(12) Patent Application Publication
(10) Pub. No.: US 2011/0116740 A1
(43) Pub. Date: May 19, 2011

(54) OPTICAL COMMUNICATION DEVICE HAVING DIGITAL OPTICAL SWITCHES

(75) Inventors: Young-Tak Han, Daejeon (KR); Jang Uk Shin, Daejeon (KR); Sang Ho Park, Daejeon (KR); Sang-Pil Han, Daejeon (KR); Yongsoon Baek, Daejeon (KR); Young-Ouk Noh, Daejeon (KR)

(73) Assignees: ELECTRONICS AND TELECOMMUNICATIONS RESEARCH; INSTITUTE, Daejeon (KR)

(21) Appl. No.: 12/704,510

(22) Filed: Feb. 11, 2010

(30) Foreign Application Priority Data
Nov. 19, 2009 (KR) 10-2009-0112039

(51) Int. Cl. G02B 6/26; G02B 6/036

(52) U.S. Cl. 385/17; 385/126

(57) ABSTRACT

Provided is an optical communication device including optical switches. The optical communication device a first multi-mode core disposed on a substrate, the first multi-mode core extending in a first direction and second multi-mode cores disposed on a substrate, the second multi-mode cores parallelly extending in a second direction non-parallel to the first direction to intersect the first multi-mode core. The heaters respectively intersect intersectional regions between the first and second multi-mode cores.

### CROSS-REFERENCE TO RELATED APPLICATIONS

This U.S. non-provisional patent application claims priority under 35 U.S.C. §119 of Korean Patent Application No. 10-2009-0112039, filed on Nov. 19, 2009, the entire contents of which are hereby incorporated by reference.

### BACKGROUND OF THE INVENTION

The present invention disclosed herein relates to an optical communication device, and more particularly, to an optical communication device having digital optical switches.

Recently, large capacity, high-speed, and high performance of an optical communication system are being increasingly required. For example, the optical communication systems may include an optical communication system using a wavelength division multiplexing (WDM) method and an optical communication system using a reconfigurable optical add-drop multiplexer (ROADM) method. For example, in the optical communication system using the ROADM method, since several channels are connected to each other at the same time, a network may be improved in utilization. Also, costs may be reduced, and a network structure may be simplified.

Optical switches are one of important elements constituting optical communication systems. An optical attenuator is well-known as an example of the optical switches. The optical attenuator is an optical device that adjusts an attenuation level of an optical signal at the outside. For example, intensity of the optical signal passing through the optical attenuator may be attenuated or may not be changed by the external adjustment.

However, as optical communication industries are developed, an optical communication system may require optical switches having various functions. Thus, many researches with respect to the optical switches that can perform novel functions are being developed.

### SUMMARY OF THE INVENTION

The present invention provides an optical communication device that switches an optical signal by changing a path of the optical signal.

The present invention also provides an optical communication device including optical switches that can improve integration.

The present invention also provides an optical communication device including optical switches that can minimize power consumption.

The present invention also provides an optical communication device including optical switches that can minimize a loss of an optical signal.

Embodiments of the present invention provide optical communication devices. The optical communication devices include: a first multi-mode core disposed on a substrate, the first multi-mode core continuously extending in a first direction; a plurality of second multi-mode cores disposed on a substrate, the second multi-mode cores extending parallel to each other in a second direction non-parallel to the first direction to intersect the first multi-mode core; a cladding surrounding the first and second multi-mode cores; and a plurality of heaters disposed on the cladding, the heaters crossing intersectional regions between the first and second multi-mode cores, respectively.

In some embodiments, when heat is supplied by the heater, the intersectional region under the heater may include a first portion to which the heat is supplied and a second portion to which the heat is not supplied. The first portion may have a refractive index lower than that of the second portion, and a reflective surface parallel to a longitudinal direction of the heater may be generated on a boundary between the first portion and the second portion.

In other embodiments, when the heat is not supplied by the heater, the first portion and the second portion may have the same refractive index.

In still other embodiments, the heater may be moved in a direction perpendicular to a longitudinal direction of the heater from a center of the intersectional region under the heater.

In even other embodiments, the optical communication devices may further include: an input single-mode core adjacent to an end of the first multi-mode core; an input taper core disposed between the input single-mode core and the end of the first multi-mode core, the input taper core being connected to the input single-mode core and the end of the first multi-mode core; a plurality of output single-mode cores adjacent to ends of the second multi-mode cores, respectively; and an output taper core disposed between each of the second multi-mode cores and each of the output single-mode cores adjacent to each other, the output taper core being connected to each of the second multi-mode cores and each of the output single-mode cores The heaters may extend in a direction different from the first and second directions.

In yet other embodiments, an acute angle between each of the heaters and the first multi-mode core may be equal to that between each of the heaters and each of the second multi-mode cores. The acute angle between each of the heaters and the first multi-mode core may be in the range of about 2° to about 20°.

In further embodiments, the first multi-mode core may be provided in plurality on the substrate. The first multi-mode cores may extend parallel to each other in the first direction. The plurality of second multi-mode cores may extend in the second direction to intersect the plurality of first multi-mode cores. The input single-mode core may be provided in plural on the substrate. The input single-mode cores may be adjacent to ends of the plurality of first multi-mode cores, respectively. The input taper core may be provided in plural on the substrate. Each of the input taper cores is connected between each of the input single-mode cores and each of the ends of the plurality of first multi-mode cores.

In still further embodiments, the heaters respectively crossing the intersectional regions between the first multi-mode cores and the second multi-mode cores may extend in the same direction.

In even further embodiments, each of the input single-mode cores may include a portion extending in a straight line and a portion extending in a curved shape. Each of the output single-mode cores may include a portion extending in a straight line and a portion extending in a curved shape.

In yet further embodiments, the number of the first multi-mode cores may be equal to that of the second multi-mode cores.

In much further embodiments, the optical communication device may further include: an additional output single-mode core adjacent to the other end of the first multi-mode core; and an additional output taper core disposed between the additional output single-mode core and the other end of the first multi-mode core, the additional output taper core being connected to the additional output taper core and the other end of the first multi-mode core. In this case, the cladding may extend to surround the additional output taper core and the additional output single-mode core. The input single-mode core, the input taper core, the first multi-mode core, the second multi-mode cores, the output single-mode cores, the output taper cores, the additional output single-mode core, and the additional output taper core may be included in a 1×N type optical switch (N=the number of the heaters+1).

In still much further embodiments, the optical communication devices may further include further comprising a 1×2 Y-branch type optical switch disposed on the substrate. The 1×2 Y-branch type optical switch may include an input port in which an optical signal is inputted, and a pair of output ports. The 1×N type optical switch may be provided in pair on the substrate. The input single-mode cores of the pair of 1×N type optical switches may be connected to the pair of output ports of the 1×2 Y-branch type optical switch, respectively. The 1×2 Y-branch type optical switch may further include a pair of optical signal control units respectively controlling optical signals of the pair of output ports. Each of the optical signal control units may control the optical signals using heat. The output single-mode core connected to the end of the second multi-mode core may include a first portion extending in a straight line, a second portion extending in a straight line, and a third portion connected between the first portion and second portion and extending in a curved shape.

In even much further embodiments, the plurality of second multi-mode cores may include a pair of second multi-mode cores. The pair of second multi-mode cores may extend in the second direction to intersect the first multi-mode core. The optical communication devices may further include a third multi-mode core extending in a third direction non-parallel to the first and second directions to intersect the pair of second multi-mode cores. In this case, the heaters may further comprise heaters respectively crossing intersectional regions between the pair of second multi-mode cores and the third multi-mode core. The cladding may extend to surround the third multi-mode core, and the third multi-mode core intersects the first multi-mode core to form an X shape. The optical communication devices may further include: a pair of input single-mode cores respectively adjacent to ends of the pair of second multi-mode cores; an input taper core disposed between each of the input single-mode cores and each of the ends of the second multi-mode cores, the input taper core being connected to each of the input single-mode cores and each of the ends of the second multi-mode cores; a pair of output single-mode cores respectively adjacent to the other ends of the pair of second multi-mode cores; and an output taper core disposed between each of the output single-mode cores and each of the other ends of the second multi-mode cores, the output taper core being connected to each of the output single-mode cores and each of the other ends of the second multi-mode cores. The cladding may extend to surround the input single-mode cores, the input taper cores, the output single-mode cores, and the output taper cores.

In yet much further embodiments, the heaters respectively crossing intersectional regions between the first multi-mode core and the pair of second multi-mode cores may extend in a fourth direction different from the first, second, and third directions. The heaters respectively crossing intersectional regions between the third multi-mode core and the pair of second multi-mode cores may extend in a fifth direction different from the first, second, third, and fourth directions.

In yet much further embodiments, the first and second multi-mode cores may be formed of polymer.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a plan view of an optical communication device according to an embodiment of the present invention;

FIG. 2 is a cross-sectional view taken along line I-I′ of FIG. 1;

FIG. 3 is a plan view of an optical communication device according to another embodiment of the present invention;

FIG. 4 is a plan view of an optical communication device according to another embodiment of the present invention;

FIG. 5 is a plan view of an optical communication device according to another embodiment of the present invention; and

FIG. 6 is a plan view of an optical communication device according to another embodiment of the present invention.

### DETAILED DESCRIPTION OF PREFERRED EMBODIMENTS

Objects, other objects, characteristics and advantages of the present invention will be easily understood from an explanation of a preferred embodiment that will be described in detail below by reference to the attached drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the specification, it will be understood that when a layer (or film) is referred to as being ‘on’ another layer or substrate, it can be directly on the other layer or substrate, or intervening layers may also be present. Also, in the figures, the dimensions of layers and regions are exaggerated for clarity of illustration. Also, though terms like a first, a second, and a third are used to describe various regions and layers in various embodiments of the present invention, the regions and the layers are not limited to these terms. These terms are used only to discriminate one region or layer from another region or layer. Therefore, a layer referred to as a first layer in one embodiment can be referred to as a second layer in another embodiment. An embodiment described and exemplified herein includes a complementary embodiment thereof. The word ‘and/or’ means that one or more or a combination of relevant constituent elements is possible. Like reference numerals refer to like elements throughout.

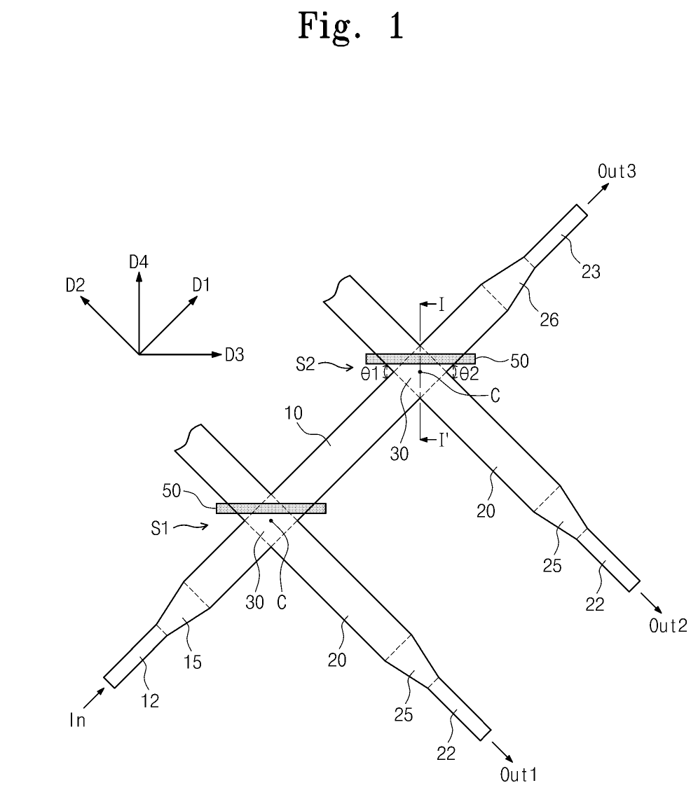

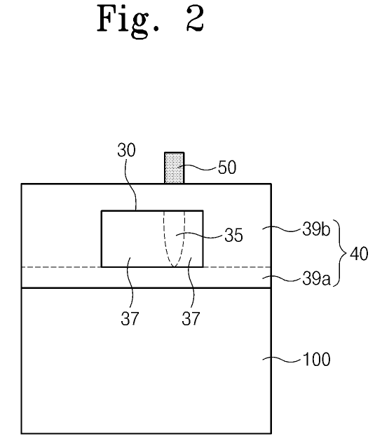

FIG. 1 is a plan view of an optical communication device according to an embodiment of the present invention, and FIG. 2 is a cross-sectional view taken along line I-I′ of FIG. 1.

Referring to FIGS. 1 and 2, a first multi-mode core 10 is disposed on a substrate 100 to continuously extend in a first direction D1. A plurality of second multi-mode cores 20 extends parallel to each other in a second direction D2 on the substrate 100 to intersect the first multi-mode core 10. Also, each of the second multi-mode cores 20 continuously extends in the second direction D2. Intersectional regions 30 between the first multi-mode core 10 and the second multi-mode cores 20 are spaced from each other. The first direction D1 is parallel to a top surface of the substrate 100. The second direction D2 is parallel to the top surface of the substrate 100 as well as non-parallel to the first direction D1. The first and second multi-mode cores 10 and 20 may be disposed at substantially the same level from the top surface of the substrate 100. Thus, the intersectional region 30 may be a portion of the first multi-mode core 10 as well as a portion of the second multi-mode core 20. The first and second multi-mode cores 10 and 20 are surrounded by a cladding (see reference numeral 40 of FIG. 2). Particularly, the cladding 40 may cover lower surfaces, sidewalls, and upper surfaces of the first and second multi-mode cores 10 and 20. For example, the cladding 40 may include a lower cladding 39a and an upper cladding 39b. The first and second multi-mode cores 10 and 20 may be disposed between the lower cladding 39a and the upper cladding 39b. The lower and upper claddings 39a and 39b may be formed of the same material. The cladding 40 may be formed of a material having a refractive index lower than those of the first and second multi-mode cores 10 and 20.

Heaters 50 are disposed on the cladding 40. The heaters 50 correspond to the intersectional regions 30, respectively. The heaters 50 cross the intersectional regions 30, respectively. The heaters 50 may extend in a third direction D3 different from the first and second directions D1 and D2. Also, the third direction D3 is parallel to the top surface of the substrate 100. All the heaters 50 may extend in the same third direction D3. That is, the heaters 50 may be parallel to each other. The heaters 50 may have rod shapes, respectively. A first acute angle ←1 between each of the heaters 50 and the first multi-mode core 10 may be equal to a second acute angle θ2 between each of the heaters 50 and the second multi-mode core 20. For example, the first acute angle θ1 may be in the range of about 2° to about 20°. Particularly, the first acute angle θ1 may be in the range of about 3° to about 10°.

An input taper core 15 and an input single-mode core 12 may be connected to an end of the first multi-mode core 10 in series. Particularly, the input taper core 15 is disposed between the input single-mode core 12 and the end of the first multi-mode core 10. The input taper core 15 has a first end connected to the end of the first multi-mode core 10 and a second end connected to the input single-mode core 12. The first end of the input taper core 15 may have a width greater than that of the second end. The input taper core 15 may have a width gradually decreasing from the first end thereof toward the second end.

An output taper core 25 and an output single-mode core 22 may be connected to an end of the second multi-mode core 20 in series. The output taper core 25 is disposed between the output single-mode core 22 and the end of the second multi-mode core 20. The output taper core 25 has a first end connected to the end of the second multi-mode core 20 and a second end connected to the output single-mode core 22. The first end of the output taper core 25 may have a width greater than that of the second end. The output taper core 25 may have a width gradually decreasing from the first end thereof toward the second end.

An additional output taper core 26 and an additional output single-mode core 23 may be connected to the other end of the first multi-mode core 10 in series. The additional output taper core 26 is disposed between the additional output single-mode core 23 and the other end of the first multi-mode core 10. The additional output taper core 26 may have a first end connected to the other end of the first multi-mode core 10 and a second end connected to the additional output single-mode core 23. The first end of the additional output taper core 26 has a width greater than that of the second end. The additional output taper core 26 may have a width gradually decreasing from the first end thereof toward the second end.

The cladding 40 illustrated in FIG. 2 extends to surround the taper cores 15, 25, and 26 and the single-mode cores 12, 22, and 23. Particularly, the taper cores 15, 25, and 26 and the single-mode cores 12, 22, and 23 may be disposed between the lower cladding 39a and the upper cladding 39b. The taper cores 15, 25, and 26 and the single-mode cores 12, 22, and 23 may be formed of a polymer.

The output single-mode cores 22 and the additional output single-mode core 23 may correspond to a first output port Out 1, a second output port Out 2, and a third output port Out 3, respectively. An optical signal may be inputted into the input single-mode core 12 and outputted through one of the output ports Out 1, Out 2, and Out 3. An operation principle related to the input/output of the optical signal will be described below in detail.

According to an embodiment, as shown in FIG. 1, the heater 50 may be moved from a center point C of the intersectional region 30 defined under the heater 50 to a fourth direction D4. That is, the heater 50 may be laterally deviated from the center point C. At this time, the fourth direction D4 is perpendicular to a longitudinal direction of the heater 50. Also, the fourth direction D4 represents a direction in which the heater 50 are away from the input taper core 15 and the output taper core 25, which are respectively connected to the ends of the first and second multi-mode cores 10 and 20 defining the intersectional region 30 under the heater 50.

Referring again to FIGS. 1 and 2, when the heater 50 is operated, the heater 50 may partially supply heat to the intersectional region 30 defined under the heater 50. Thus, as shown in FIG. 2, the intersectional region 30 may include a first portion 35 to which the heat is supplied and a second portion 37 to which the heat is not supplied. When the heater 50 is operated to supply the heat, the first portion 35 has a refractive index lower than that of the second portion 37 due to a thermo-optic effect. As a result, a reflective surface extending in the longitudinal direction of the heater 50 is generated on a boundary between the first and second portions 35 and 37. The first and second multi-mode cores 10 and 20 may be formed of a polymer having a superior thermo-optic effect. The first and second multi-mode cores 10 and 20 may be formed of the same material. The optical signal inputted into the input single-mode core 12 may be totally reflected at the reflective surface and then outputted to the output single-mode core 22 through the second multi-mode core 20 connected to the intersectional region 30. As shown in FIG. 1, the heater 50 may be disposed on portions of the first and second multi-mode cores 10 and 20 adjacent to the intersectional region 30. In this case, the reflective surface of the first portion 35 may extend into the portions of the first and second multi-mode cores 10 and 20 in the longitudinal direction of the heater 50. The first portion 35 may have a nonlinearly inclined surface. Thus, the reflective surface may be nonlinearly inclined.

When the heater 50 is not operated, the heat is not supplied to the first portion 35. Thus, the thermo-optic effect does not occur. As a result, the reflective surface disappears. In this case, the optical signal inputted into the input single-mode core 12 passes through the intersectional region 30 and proceeds into the first multi-mode core 10.

As a result, the optical signal inputted into the input single-mode core 12 may be changed in path according to the operation of the heater 50. The heater 50 and the intersectional region 30 under the respective heaters 50 may be included in one optical switch. As shown in FIG. 1, an optical switch including the intersectional region 30 connected to the first output port Out 1 and the heater 50 disposed above the intersectional region 30 are defined as a first optical switch S1. Also, an optical switch including the intersectional region 30 connected to the second output port Out 2 and the heater 50 disposed above the intersectional region 30 are defined as a second optical switch S2.

An operation principle of the optical communication device of FIG. 1 will be described. The optical signal inputted into the input single-mode core 12 may be outputted through one of the first, second, third output ports Out 1, Out 2, and Out 3 according to operations of the first and second optical switches S1 and S2. For example, when the first optical switch S1 is operated, the heater 50 of the first optical switch S1 is operated to generate a reflective surface within the first optical switch S1. Thus, the inputted optical signal is outputted through the first output port Out 1 via the second multi-mode core 20. On the other hand, when the first optical switch S1 is not operated, but the second optical switch is operated, the inputted optical signal is outputted through the second output port Out 2. Also, when all of the first and second optical switches S1 and S2 are not operated, the inputted optical signal passing through the intersectional regions 30 is outputted through the third output port Out 3 connected to the other end of the first multi-mode core 10.

The optical signal inputted through the input single-mode core 12 may be adiabatically changed without exciting a higher-order mode by the input taper core 15 and proceeds into the first multi-mode core 10. The optical signal proceeding into the second multi-mode core 20 may have a fundamental mode form. The outputted optical signal may be adiabatically changed in a state where it is maintained into the fundamental mode form by the output taper core 25. In other words, the higher-order mode of the optical signal may not be excited by the output taper core 25 to prevent losses due to the higher-order mode from occurring.

According to the above-described optical communication device, the optical switch in the optical communication device changes the propagation direction of the optical signal using a total reflection effect. The first multi-mode core 10 and the second multi-mode cores 20 are intersected over each other to form a plurality of the optical switches S1 and S2. Thus, the optical communication device may be simplified in structure to improve an integration level of the devices. Also, the multi-mode cores 10 and 20 may be formed of a polymer having a high thermo-optic coefficient and realize the optical switch using the total reflection effect to minimize power consumption. The intersectional regions 30 in which the optical switches S1 and S2 are formed are connected to the continuously extending first multi-mode core 10. That is, only the multi-mode core is disposed between the intersectional regions 30. As a result, a distance between the optical switches S1 and S2 may be minimized to further improve the integration level of the optical communication devices. In addition, since all of the intersectional regions 30 in which the optical switches S1 and S2 and the core between the intersectional regions 30 are multi-mode cores, transition of a waveguide core between the optical switches S1 and S2 is not required. Therefore, the losses of the optical signal by the transition of the waveguide core may be prevented, and also, the optical communication device may be further simplified in structure.

Hereinafter, other embodiments in which the spirits of the present invention is applied will be described with reference to accompanying drawings.

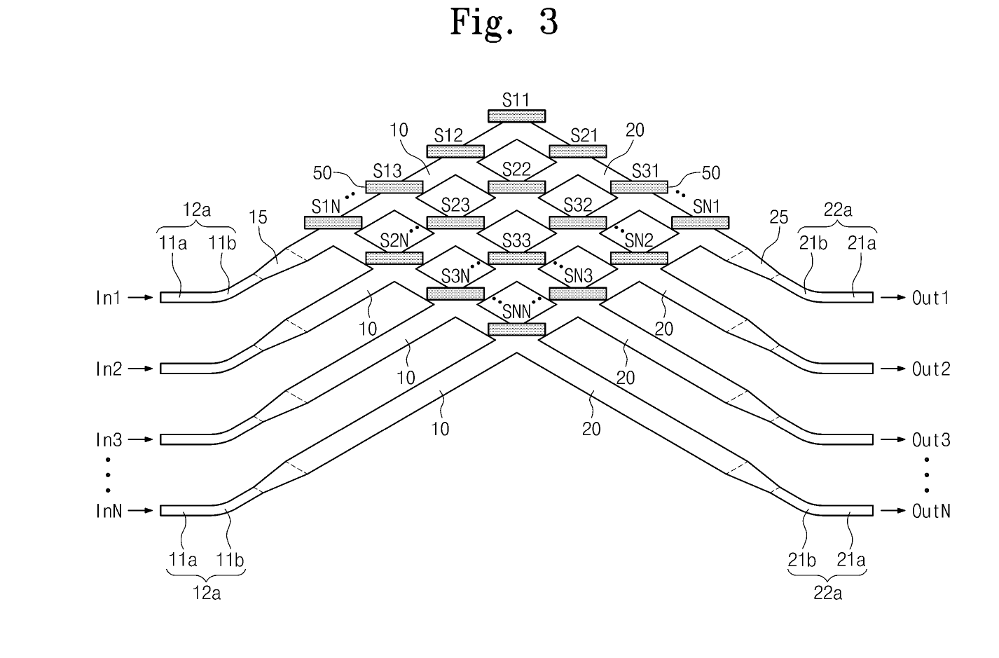

FIG. 3 is a plan view of an optical communication device according to another embodiment of the present invention.

Referring to FIG. 3, a plurality of first multi-mode cores 10 extend parallel to each other in a first direction. Each of the first multi-mode cores 10 continuously extends. A plurality of second multi-mode cores 20 extend parallel to each other in a second direction different from the first direction, such that the second multi-mode cores 20 intersect the plurality of first multi-mode cores 10. Each of the second multi-mode cores 20 continuously extend in the second direction. The first multi-mode cores 10 may have the same number as that of the second multi-mode cores 20. Intersectional regions between the first multi-mode cores 10 and the second multi-mode cores 20 are two-dimensionally arranged. That is, the intersectional regions are two-dimensionally arranged along the first multi-mode cores 10 and the second multi-mode cores 20. A heater 50 is disposed on each of the intersectional regions. Thus, the heaters 50 may be two-dimensionally arranged along the first multi-mode cores 10 and the second multi-mode cores 20. One optical switch includes each of the intersectional regions and the heater 50 disposed on each of the intersectional regions. Thus, a plurality of optical switches S11, S12, S13, . . . , S1N, S21, S22, S23, . . . , S2N, S31, S32, S33, . . . , S3N, and SN1, SN2, SN3, . . . , SNN may be arranged in matrix form. The heaters 50 disposed on the intersectional regions may extend in the same direction. As shown in FIG. 1, the heater 50 may be in a state that is deviated from a center of each of the intersectional regions under the heater 50.

An input taper core 15 and an input single-mode core 12a may be successively connected to an end of each of the first multi-mode cores 10. Thus, a plurality of the input single-mode cores 12a respectively corresponding to the ends of the first multi-mode cores 10 may be provided. An output taper core 25 and an output single-mode core 22a may be successively connected to an end of each of the second multi-mode cores 20. Thus, a plurality of the output single-mode cores 22a respectively corresponding to the ends of the second multi-mode cores 20 may be provided. Each of the input single-mode cores 12a may include a first portion 11a extending in a straight line and a second portion 11b bent in a curved shape. An optical signal may proceed along a configuration of the second portion 11b in the curved shape within the second portion 11b of the input single-mode core 12a. Similarly, each of the output single-mode cores 22a may include a first portion 21a extending in a straight line and a second portion 21b bent in a curved shape. The first and second multi-mode cores 10 and 20, the taper cores 15 and 25, and the single-mode cores 12a and 22a are surrounded by the cladding (see reference numeral 40 of FIG. 2).

The input single-mode cores 12a may correspond to a plurality of input ports In1, In2, In3 . . . InN, respectively. And the output single-mode cores 22a may correspond to a plurality of output ports Out1, Out2, Out3, . . . , OutN, respectively. Thus, an N×N matrix optical switch may be realized by the optical switches S11, S12, S13, . . . , S1N, S21, S22, S23, . . . , S2N, S31, S32, S33, . . . , S3N, and SN1, SN2, SN3, . . . , SNN, the input ports In1, In2, In3, . . . , InN, and the output ports Out1, Out2, Out3, . . . , OutN.

An operation principle of the optical communication device of FIG. 3 will be described. An optical signal inputted into the first input port In1 may outputted through one of the plurality of output ports Out1, Out2, Out3, . . . , OutN by controlling operations of the optical switches S11, S12, S13 . . . S1N connected to the first input port In1. Particularly, when an optical switch selected from the optical switches S11, S12, S13, . . . , S1N, S21, S22, S23, . . . , S2N, S31, S32, S33, . . . , S3N, and SN1, SN2, SN3, . . . , SNN is operated and unselected optical switches are not operated, an optical signal inputted into an input port connected to the selected optical switch may be outputted through an output port connected to the selected optical switch.

For example, when an optical signal is inputted into the first input port In1 in a state where a 12-th optical switch S12 is operated, and the remaining optical switches S11, S13, . . . , S1N, S21, S22, S23, . . . , S2N, S31, S32, S33, . . . , S3N, and SN1, SN2, SN3, . . . , SNN are not operated, the inputted optical signal may be outputted through a second output port Out2. For another example, when a 31-th optical switch S31 is operated, and the remaining optical switches S11, S12, S13, . . . , S1N, S21, S22, S23, . . . , S2N, S32, S33, . . . , S3N, and SN1, SN2, SN3, . . . , SNN are not operated, an optical signal inputted into a third input port In3 may be outputted through a first output port Out1. According to an embodiment, when the number of the first multi-mode cores 10 are sixteen and the number of the second multi-mode cores 20 are sixteen, a 16×16 type optical matrix switch may be realized. However, the present invention is not limited thereto. An N×N type optical matrix switch having a different form may be realized.

Since the above-described N×N type optical matrix switch includes the first and second multi-mode cores 10 and 20 and the heaters 50, a highly integrated optical communication device may be realized. Also, an optical loss may be minimized.

According to an embodiment of the present invention, the number of the first multi-mode cores 10 and the number of the second multi-mode cores 20 may be different from each other. As a result, an M×N type optical matrix switch may be realized (here, reference symbols M and N represent natural numbers different from each other, and reference symbol N is a natural number greater than 2).

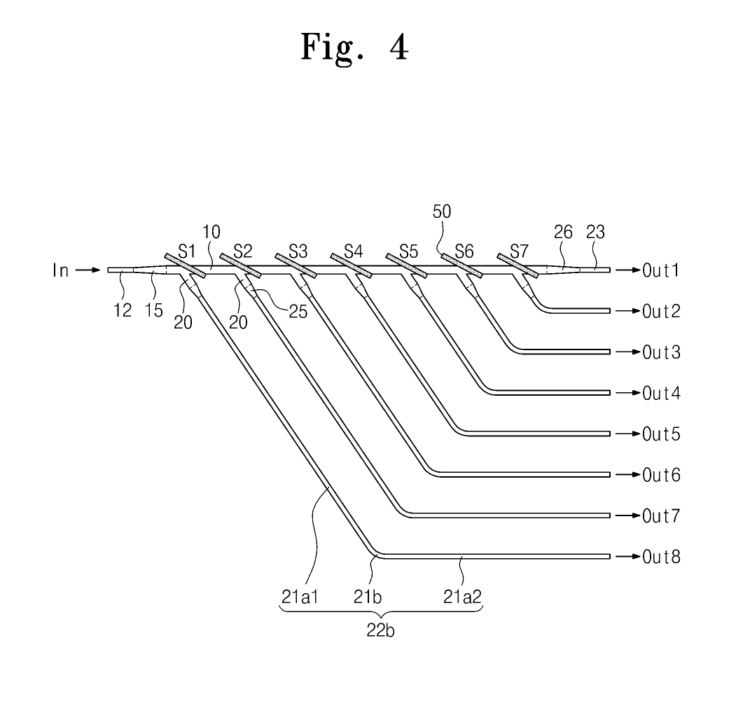

FIG. 4 is a plan view of an optical communication device according to another embodiment of the present invention.

Referring to FIG. 4, in an embodiment, an optical communication device may include a 1×N type optical switch. Particularly, the 1×N type optical switch includes one first multi-mode core 10 and a plurality of second multi-mode cores 20. The first multi-mode core 10 extends in a first direction, and the plurality of second multi-mode cores 20 extends in a second direction to intersect the first multi-mode core 10. The 1×N type optical switch may further include heaters 50 respectively disposed above intersectional regions between the first and second multi-mode cores 10 and 20. Each of the heaters 50 and the intersectional region under each of the heaters 50 may be included in one optical switch. Thus, a plurality of optical switches S1, S2, S3, S4, S5, S6, and S7 may be arranged at the first multi-mode core 10. The 1×N type optical switch may further include an input taper core 15 and an input single-mode core 12, which are sequentially connected to one end of the first multi-mode core 10. An output taper core 25 and an output single-mode core 22b, which are sequentially connected to one end of the second multi-mode core 20. Also, the 1×N type optical switch may further include an additional output taper core 26 and an additional output single-mode core 23, which are sequentially connected to the other end of the first multi-mode core 10. The output single-mode core 22b may include a first portion 12a1 extending in a straight line, a second portion 21a2 extending in a straight line, and a third portion 21b connected between the first and second portions 21a1 and 21a2. The third portion 21b may be bent in a curved shape. A longitudinal direction of the first portion 21a1 may be longitudinal different from a longitudinal direction of the second portion 21a2.

The additional output single-mode core 23 and the output single-mode cores 22b may correspond to a plurality of output ports Out1, Out2, Out3, . . . , Out8, respectively. As the additional output single-mode core 23 is used as one of the plurality of output ports Out1, Out2, Out3, . . . , Out8, the 1×N type optical switch may require N−1 optical switches. In other words, an N number of the 1×N type optical switch is equal to that obtained by adding a natural number 1 to the number of the optical switches.

A 1×8 type optical switch is illustrated in FIG. 4. The 1×8 type optical switch may include seven optical switches S1, S2, S3, . . . , S7. When all of the optical switches S1, S2, S3, . . . , S7 are not operated, an optical signal inputted into the input single-mode core 12 may be outputted through the additional single-mode core 23. Also, when an optical switch selected from the optical switches S1, S2, S3, . . . , S7 is operated, and the remaining optical switches are not operated, the inputted optical signal may be outputted through an output port connected to the selected optical switch. For example, when a third optical switch S3 is operated, and the remaining optical switches S1, S2, S4, . . . , S7 are not operated, the inputted optical signal may be outputted through a sixth output port Out6 connected to the third optical switch S3. Although the 1×8 type optical switch is illustrated in FIG. 4, the present invention is not limited thereto. The present invention may be realized as an optical communication device including a 1×N type optical switch having a different form.

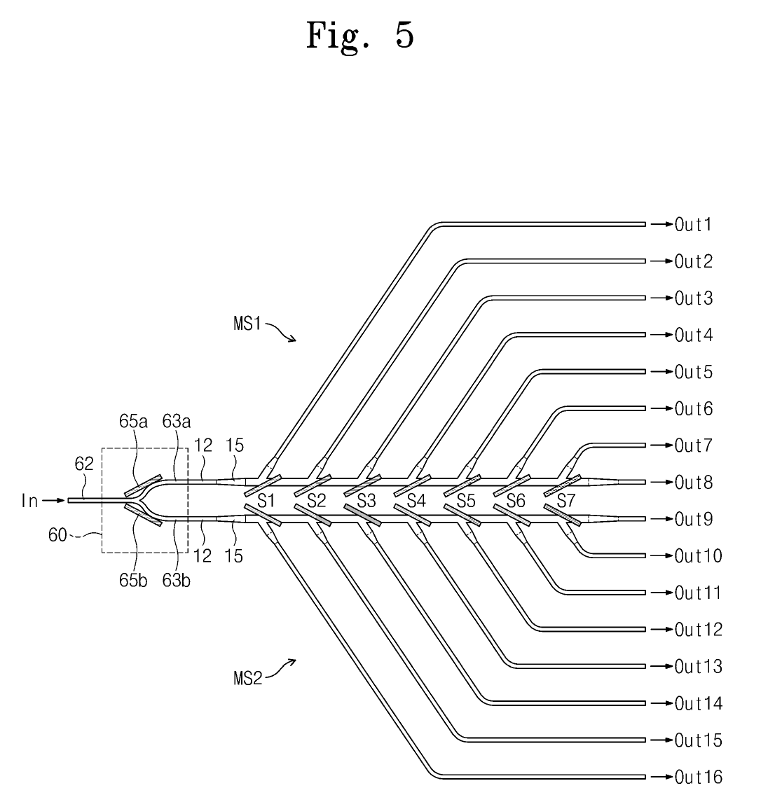

FIG. 5 is a plan view of an optical communication device according to another embodiment of the present invention.

Referring to FIG. 5, an optical communication device may include a 1×2 Y-branch type optical switch 60 including an input port 62 and a pair of output ports 63a and 63b. The 1×2 Y-branch type optical switch 60 may further include a pair of optical signal control units 65a and 65b for respectively controlling optical signals of the pair of output ports 63a and 63b. The optical communication device may further include a pair of 1×N type optical switches MS1 and MS2. The 1×N type optical switches MS1 and MS2 are connected to the pair of output ports 63a and 63b, respectively.

Specifically, the 1×N type optical switch MS1 or MS2 may have the same structure as the 1×N type optical switch described with reference to FIG. 4. An input single-mode core 12 of first 1×N type optical switch MS1 may be connected to the first output port 63a of the 1×2 Y-branch type optical switch 60, and an input single-mode core 12 of second 1×N type optical switch MS2 may be connected to the second output port 63b of the 1×2 Y-branch type optical switch 60.

First optical signal control unit 65a may be disposed at a side of the first output port 63a of the 1×2 Y-branch type optical switch 60, and second optical signal control unit 65b may be disposed at a side of the second output port 63b of the 1×2 Y-branch type optical switch 60. The first and second output ports 63a and 63b may be disposed between the first and second optical signal control units 65a and 65b. The first and second optical signal control units 65a and 65b may control the optical signals of the first and second output ports 63a and 63b using heat. For example, when the first optical signal control unit 65a supplies heat for the first output port 63a, the first output port 63a may intercept the optical signal. On the other hand, when the first optical signal control unit 65a does not supply the heat, the optical signal may be outputted through the first output port 63a. Similarly, the second optical signal control unit 65b may control the second output port 63b using the same method as that of the first optical signal control unit 65a. For example, the first and second optical signal control units 65a and 65b may be heaters.

An operation principle of the optical communication device of FIG. 5 will be described. An optical signal inputted into the input port 62 is outputted through one of the first and second output ports 63a and 63b according to operations of the first and second optical signal control units 65a and 65b. For example, when the first optical signal control unit 65a is operated, and the second optical signal control unit 65b is not operated, the inputted optical signal is outputted through the second output port 63b and inputted into the input single-mode core 12 of the second 1×N type optical switch MS2. The operation principle of each of the first and second 1×N type optical switches MS1 and MS2 may be equal to that described with reference to FIG. 4. The 1×2 Y-branch type optical switch 60 and the pair of 1×N type optical switches MS1 and MS2 connected to the 1×2 Y-branch type optical switch 60 may realize a 1×2N type optical switch. For example, when each of the 1×N type optical switches MS1 and MS2 includes a 1×8 type optical switch, the optical communication device of FIG. 5 may be realized as a 1×16 type optical switch.

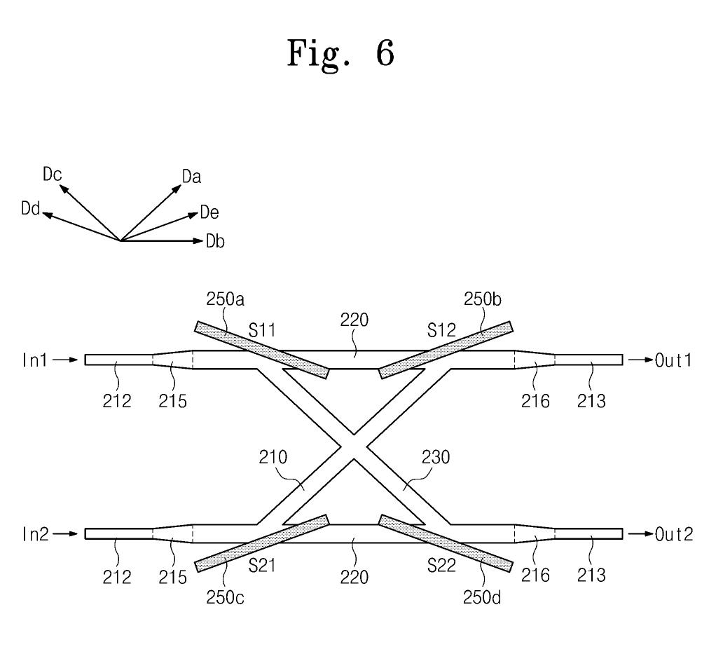

FIG. 6 is a plan view of an optical communication device according to another embodiment of the present invention.

Referring to FIG. 6, an optical communication device according to this embodiment may include a 2×2 type optical switch. The 2×2 type optical switch may include a first multi-mode core 210, a pair of second multi-mode cores 220, and a third multi-mode core 230. The first multi-mode core 210 continuously extends in a first direction Da. The pair of second multi-mode cores 220 extend parallel to each other in a second direction Db to intersect the first multi-mode core 210. The second direction Db is non-parallel to the first direction Da. Each of the second multi-mode cores 220 continuously extends in the second direction Db. The third multi-mode core 230 extends continuously in a third direction Dc to intersect the pair of second multi-mode cores 220. The third direction Dc is non-parallel to the first and second directions Da and Db. In addition, the third multi-mode core 230 may intersect the first multi-mode core 210 to form an X shape. The first, second, and third multi-mode cores 210, 220, and 230 may have the same material and function as the first multi-mode core 10 described with reference to FIG. 1.

An input taper core 215 and an input single-mode core 212 may be sequentially connected to one end of each of the second multi-mode cores 220. And an output taper core 216 and an output single-mode core 213 may be sequentially connected to the other end of each of the second multi-mode cores 220. The input taper core 215 and the output taper core 216 may be formed of the same material as the input taper core 15 and the output taper core 25 described with reference to FIG. 1. Similarly, the input single-mode core 212 and the output single-mode core 213 may be formed of the same material as the input single-mode core 12 and the output single-mode core 22 described with reference to FIG. 1. Also, the input single-mode core 212 and the output single-mode core 213 may have the same function as the input single-mode core 12 and the output single-mode core 22.

The 2×2 type optical switch may further include a cladding surrounding the multi-mode cores 210, 220, and 230, the taper cores 215 and 216, and the single-mode cores 212 and 213. In addition, the 2×2 type optical switch may further include heaters 250b and 250c disposed on the cladding to intersect intersectional regions between the first and second multi-mode cores 210 and 220 and heaters 250a and 250d disposed on the cladding to intersect intersectional regions between the second and third multi-mode cores 220 and 230. A heater may be not disposed above a intersectional region between first and third multi-mode cores 210 and 230.

a pair of the input single-mode cores 212 may correspond to a first input port In1 and a second input port In2, respectively. Also, a pair of the output single-mode cores 213 may correspond to a first output port Out1 and a second output port Out2, respectively. The heaters 250a and 250b disposed on the second multi-mode core 220 connected to the first input port In1 are defined as a first heater 250a and a second heater 250b, respectively. The heaters 250c and 250d disposed on the second multi-mode core 220 connected to the second input port In2 are defined as a third heater 250c and a fourth heater 250d, respectively.

An acute angle between the first heater 250a and the third multi-mode core 230 may be equal to that between the first heater 250a and the second multi-mode core 220 intersecting the first heater 250a. The acute angle between the first heater 250a and the third multi-mode core 230 may be in the range of about 2° to about 20°. Particularly, the acute angle between the first heater 250a and the third multi-mode core 230 may be in the range of about 3° to about 10°. An acute angle between the second heater 250b and the first multi-mode core 210 may be equal to that between the second heater 250b and the second multi-mode core 220 intersecting the second heater 250b. The acute angle between the second heater 250b and the second multi-mode core 220 may be in the range of about 2° to about 20°. Particularly, the acute angle between the second heater 250b and the second multi-mode core 220 may be in the range of about 3° to about 10°. Since the first multi-mode core 210 and the third multi-mode core 230 extend in the first direction and the third direction, respectively, a fourth direction Dd in which the first heater 250a extends is different from a fifth direction De in which the second heater 250b extends. The first heater 250a and the second heater 250b may have symmetrical structures with each other.

Similarly, an acute angle between the third heater 250c and the first multi-mode core 210 may be equal to that between the third heater 250c and the second multi-mode core 220 intersecting the third heater 250c. The acute angle between the third heater 250c and the first multi-mode core 210 may be in the range of about 2° to about 20°. Particularly, the acute angle between the third heater 250c and the first multi-mode core 210 may be in the range of about 3° to about 10°. An acute angle between the fourth heater 250d and the third multi-mode core 230 may be equal to that between the fourth heater 250d and the second multi-mode core 220 intersecting the fourth heater 250d. The acute angle between the fourth heater 250d and the third multi-mode core 230 may be in the range of about 2° to about 20°. Particularly, the acute angle between the fourth heater 250d and the third multi-mode core 230 may be in the range of about 3° to about 10°. The third heater 250c and the fourth heater 250d may have symmetrical structures with each other.

The second heater 250b and the third heater 250c disposed above the intersectional regions between the first multi-mode core 210 and the pair of second multi-mode cores 220 may extend in the same direction as each other. Also, the first heater 250a and the fourth heater 250d disposed above the intersectional regions between the third multi-mode core 230 and the pair of second multi-mode cores 220 may extend in the same direction as each other. Each of the heaters 250a, 250b, 250c and 250d may be moved in a direction perpendicular to a longitudinal direction of each of the heaters 250a, 250b, 250c and 250d from a center point of the intersectional region under each of the heaters 250a, 250b, 250c and 250d. The first to fourth heaters 250a, 250b, 250c and 250d are included in first, second, third, and fourth optical switches S11, S12, S21, and S22 arranged in a 2×2 matrix form, respectively.

An operation principle of the above-described 2×2 type optical switch will be described. When the first optical switch S11 and the second optical switch S12 are not operated, an optical signal inputted into a first input port In1 is outputted through a first output port Out1. On the other hand, when the first optical switch S11 and the fourth optical switch S22 are operated, the optical signal inputted into the first input port In1 is outputted through a second output port Out2 via the third multi-mode core 230. An optical signal inputted into a second input port In2 may be outputted through the first output port Out1 via the first multi-mode core 210 by operations of the second and third optical switches S12 and S21. When the third and fourth optical switches S21 and S22 are not operated, the optical signal inputted into the second input port In2 is outputted through the second output port Out2.

According to the above-described optical communication device, the heaters intersect the intersectional regions between the first multi-mode core and the plurality of second multi-mode cores. Thus, the plurality of optical switches may be realized. Due to this structure, the optical communication device may decrease in size, and its structure may be simplified to improve the integration level of the optical communication devices.

Also, according an embodiment, the multi-mode cores may be formed of the polymer having a high thermo-optic coefficient. Due to the multi-mode cores formed of the polymer having a high thermo-optic coefficient as well as the operation characteristic of the optical switch using the total reflection effect, power consumption may be minimized.

Also, since the first multi-mode core sequentially extends, the intersectional regions are connected to the sequentially extending first multi-mode core. Thus, a distance between the optical switches respectively including the heaters may be minimized to further improve the integration level of the optical communication devices, thereby minimizing the loss of the optical signal.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An optical communication device comprising:
a first multi-mode core disposed on a substrate, the first multi-mode core continuously extending in a first direction;
a plurality of second multi-mode cores disposed on a substrate, the second multi-mode cores extending parallel to each other in a second direction non-parallel to the first direction to intersect the first multi-mode core;
a cladding surrounding the first and second multi-mode cores; and
a plurality of heaters disposed on the cladding, the heaters crossing intersectional regions between the first and second multi-mode cores, respectively.

2. The optical communication device of claim 1, wherein, when heat is supplied by the heater, the intersectional region under the heater comprise a first portion to which the heat is supplied and a second portion to which the heat is not supplied, the first portion has a refractive index lower than that of the second portion, and a reflective surface parallel to a longitudinal direction of the heater is generated on a boundary between the first portion and the second portion.

3. The optical communication device of claim 2, wherein, when the heat is not supplied by the heater, the first portion and the second portion have the same refractive index.

4. The optical communication device of claim 1, wherein the heater is moved in a direction perpendicular to a longitudinal direction of the heater from a center of the intersectional region under the heater.

5. The optical communication device of claim 1, further comprising:
an input single-mode core adjacent to an end of the first multi-mode core;
an input taper core disposed between the input single-mode core and the end of the first multi-mode core, the input taper core being connected to the input single-mode core and the end of the first multi-mode core;
a plurality of output single-mode cores adjacent to ends of the second multi-mode cores, respectively; and
an output taper core disposed between each of the second multi-mode cores and each of the output single-mode cores adjacent to each other, the output taper core being connected to each of the second multi-mode cores and each of the output single-mode cores,
wherein the heaters extend in a direction different from the first and second directions.

6. The optical communication device of claim 5, wherein an acute angle between each of the heaters and the first multi-mode core is equal to that between each of the heaters and each of the second multi-mode cores.

7. The optical communication device of claim 6, wherein the acute angle between each of the heaters and the first multi-mode core is in the range of about 2° to about 20°.

8. The optical communication device of claim 5, wherein the first multi-mode core is provided in plural on the substrate, the first multi-mode cores extending parallel to each other in the first direction,
the plurality of second multi-mode cores extends in the second direction to intersect the first multi-mode cores,
the input single-mode core is provided in plural on the substrate,
the input single-mode cores are adjacent to ends of the first multi-mode cores, respectively, and
the input taper core is provided in plural on the substrate, and
each of the input taper core is connected between each of the input single-mode core and each of the ends of the first multi-mode cores adjacent to each other, each of the input

9. The optical communication device of claim 8, wherein the heaters respectively crossing the intersectional regions between the first multi-mode cores and the second multi-mode cores extend in the same direction.

10. The optical communication device of claim 8, wherein each of the input single-mode cores comprises a portion extending in a straight line and a portion extending in a curved shape, and
each of the output single-mode cores comprises a portion extending in a straight line and a portion extending in a curved shape.

11. The optical communication device of claim 8, wherein the number of the first multi-mode cores is equal to that of the second multi-mode cores.

12. The optical communication device of claim 5, further comprising:
an additional output single-mode core adjacent to the other end of the first multi-mode core; and
an additional output taper core disposed between the additional output single-mode core and the other end of the first multi-mode core, the additional output taper core being connected to the additional output single-mode core and the other end of the first multi-mode core,
wherein the cladding extends to surround the additional output taper core and the additional output single-mode core, and
the input single-mode core, the input taper core, the first multi-mode core, the second multi-mode cores, the output single-mode cores, the output taper cores, the additional output single-mode core, and the additional output taper core are included in a 1×N type optical switch (N=the number of the heaters+1).

13. The optical communication device of claim 12, further comprising a 1×2 Y-branch type optical switch disposed on the substrate, and including an input port, in which an optical signal is inputted, and a pair of output ports,
wherein the 1×N type optical switch is provided in pair on the substrate, and the input single-mode cores of the pair of 1×N type optical switches are connected to the pair of output ports of the 1×2 Y-branch type optical switch, respectively.

14. The optical communication device of claim 13, wherein the 1×2 Y-branch type optical switch further comprises a pair of optical signal control units respectively controlling optical signals of the pair of output ports,
wherein each of the optical signal control units controls the optical signals using heat.

15. The optical communication device of claim 12, wherein the output single-mode core connected to the end of the second multi-mode core comprises a first portion extending in a straight line, a second portion extending in a straight line, and a third portion connected between the first portion and second portion and extending in a curved shape.

16. The optical communication device of claim 1, wherein the plurality of second multi-mode cores comprises a pair of second multi-mode cores, and the pair of second multi-mode cores extends in the second direction to intersect the first multi-mode core,
the optical communication device further comprises: a third multi-mode core extending in a third direction non-parallel to the first and second directions to intersect the pair of second multi-mode cores,
wherein the heaters further comprises heaters respectively crossing intersectional regions between the pair of second multi-mode cores and the third multi-mode core, and
the cladding extends to surround the third multi-mode core, and the third multi-mode core intersects the first multi-mode core to form an X shape.

17. The optical communication device of claim 16, further comprising:
a pair of input single-mode cores respectively adjacent to ends of the pair of second multi-mode cores;
an input taper core disposed between each of the input single-mode cores and each of the ends of the second multi-mode cores adjacent to each other, the input taper core being connected to each of the input single-mode cores and each of the ends of the second multi-mode cores;
a pair of output single-mode cores respectively adjacent to the other ends of the pair of second multi-mode cores; and
an output taper core disposed between each of the output single-mode cores and each of the other ends of the second multi-mode cores adjacent to each other, the output taper core being connected to each of the output single-mode cores and each of the other ends of the second multi-mode cores,
wherein the cladding extends to surround the input single-mode cores, the input taper cores, the output single-mode cores, and the output taper cores.

18. The optical communication device of claim 17, wherein the heaters crossing intersectional regions between the third multi-mode core and the pair of second multi-mode cores extend in a fourth direction different from the first, second, and third directions, and
the heaters crossing intersectional regions between the first multi-mode core and the pair of second multi-mode cores extend in a fifth direction different from the first, second, third, and fourth directions.

19. The optical communication device of claim 17, wherein each of the heaters is moved in a direction perpendicular to a longitudinal direction of each of the heaters from a center point of the intersectional region under the respective heaters and adjacent to the respective heaters.

20. The optical communication device of claim 1, wherein the first and second multi-mode cores are formed of polymer.
